(19) United States
(12) Patent Application Publication
(10) Pub. No.: US 2017/0150393 A1
(43) Pub. Date: May 25, 2017

(54) Dynamic Quality of Service Management

(71) Applicant: Nokia Solutions and Networks Oy, Espoo (FI)

(72) Inventors: Wolfgang PAYER, Ulm (DE); Hans KROENER, Geislingen (DE); Carsten RITTERHOFF, Olching (DE)

(21) Appl. No.: 15/315,544

(22) PCT Filed: Jun. 13, 2014
(86) PCT No.: PCT/EP2014/062396

§ 371 Date: Dec. 1, 2016

(51) Int. Cl. H04W 28/02; H04L 12/26; H04W 72/12

(52) U.S. Cl. CPC H04W 28/0268; H04W 72/1242; H04L 43/0888

(57) ABSTRACT

There are provided measures for dynamic quality of service management. Such measures exemplarily include queuing, for a bearer being a virtual connection with associated bearer transmission attributes aggregating at least one packet flow of packets, each of said at least one packet flow separately, and prioritizing each of said at least one packet flow based on a desired treatment of said respective packet flow.

### FIELD

The present invention relates to dynamic quality of service management. More specifically, the present invention exemplarily relates to measures (including methods, apparatuses and computer program products) for realizing dynamic quality of service management.

### BACKGROUND

The present specification generally relates to management of traffic in wireless network deployments like 3^{rd} Generation Partnership Project (3GPP) Long Term Evolution (LTE) and the like such a required quality of service for a data flow which may for example be determined by the type of the application generating the data flow can be met with a minimum amount of resources (e.g., air/radio interface resource in an evolved NodeB (eNodeB, eNB)). Dynamic quality of service (QoS) management may be considered as an approach to ensure an adequate quality of experience to the user especially when congestion occurs while at the same time ensuring efficient resource utilization for operators benefit.

In typical scenarios, a QoS manager (e.g. a LTE QoS manager) is an entity in an enhanced packet core (EPC) having access to load/congestion information of other network elements as well as to immediate performance data of a (data) flow, user subscription, etc. QoS enforcement points may be located in different places in such a network deployment.

The native QoS framework in LTE offers a layered approach where data flows are associated with bearers in the EPC, and each bearer is associated with a well known identifier (quality of service class identifier (QoS class identifier, QCI)). The QCI is a means to indicate a preferred treatment of a bearer and to enforce this consistently over multiple bearers of a single user equipment (UE) as well as between multiple UEs in the eNB (possible QoS enforcement point for the radio interface) without a need to know about the application or other higher layer information. A bearer is an aggregate of multiple data flows receiving the same QoS treatment.

FIG. 1 is a schematic diagram illustrating details of a layer 2 structure of an existing QoS framework in a downlink (DL) direction, in particular a layer 2 structure according to 3GPP technical specification (TS) 36.300.

The existing QoS framework allows for differentiation only between multiple bearers of a UE. In the user plane protocol stack, each radio bearer corresponds to a logical channel. There is a single radio link control (RLC) and a single packet data convergence protocol (PDCP) layer entity per logical channel, through which all the data of the bearer is transferred.

Services provided by the RLC sub-layer may include (but are not limited to) concatenation, segmentation and reassembly of RLC service data units (SDU), reordering of RLC data protocol data units (PDU) and duplicate detection. Services provided by PDCP sub-layer may include (but are not limited to) ciphering and deciphering and insequence delivery of upper layer PDUs for specific cases.

The mentioned framework, however, is considered quite often as lacking sufficient flexibility and granularity with respect to the treatment of single data flows as the number of different bearers per UE is limited.

Furthermore, the concept of multiple bearers per UE has never really been adopted widely in Universal Mobile Telecommunications System (UMTS) networks, and a more flexible treatment may be desired to be in UMTS and LTE similarly.

In addition, IP networks are also more flexible as basically each packet could carry a mark determining a desired treatment at a given point in time.

Hence, the problem arises that flexibility with respect to the treatment of single data flows is desired in order to allow for a more granular and dynamic treatment of packet flows within a bearer.

Hence, there is a need to provide for dynamic quality of service management.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising queuing, for a bearer being a virtual connection with associated bearer transmission attributes aggregating at least one packet flow of packets, each of said at least one packet flow separately, and prioritizing each of said at least one packet flow based on a desired treatment of said respective packet flow.

According to an exemplary aspect of the present invention, there is provided an apparatus comprising queuing means configured to queue, for a bearer being a virtual connection with associated bearer transmission attributes aggregating at least one packet flow of packets, each of said at least one packet flow separately, and prioritizing means configured to prioritize each of said at least one packet flow based on a desired treatment of said respective packet flow.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient and seamless bearer and flow differentiation at the same time which allows maximum flexibility for QoS differentiation to thereby solve at least part of the problems and drawbacks identified in relation to the prior art. Aspects of the present invention are easily adaptable within existing eNB software architecture and implementation of service differentiation.

By way of exemplary embodiments of the present invention, there is provided dynamic quality of service management. More specifically, by way of exemplary embodiments of the present invention, there are provided measures and mechanisms for realizing dynamic quality of service management.

Thus, improvement is achieved by methods, apparatuses and computer program products enabling/realizing dynamic quality of service management, and in particular by methods, apparatuses and computer program products enabling/realizing per packet dynamic quality of service management.

### BRIEF DESCRIPTION OF THE DRAWINGS

In the following, the present invention will be described in greater detail by way of non-limiting examples with reference to the accompanying drawings, in which

FIG. 1 is a schematic diagram illustrating details of a layer 2 structure of an existing QoS framework in a downlink direction,

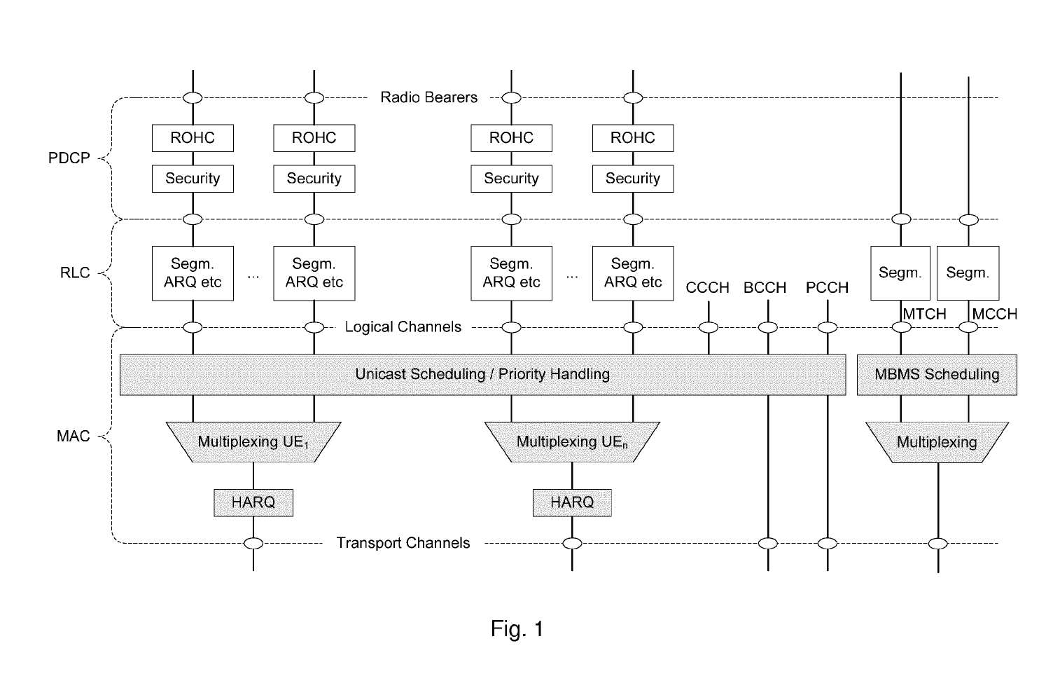

FIG. 2 is a block diagram illustrating an apparatus according to exemplary embodiments of the present invention,

FIG. 3 is a block diagram illustrating an apparatus according to exemplary embodiments of the present invention,

FIG. 4 is a schematic diagram of a procedure according to exemplary embodiments of the present invention,

FIG. 5 is a schematic diagram illustrating details of a layer 2 structure according to exemplary embodiments of the present invention, and

FIG. 6 is a block diagram alternatively illustrating an apparatus according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, LTE is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) dynamic quality of service management.

In order that the required quality of service for the flow meets a minimum amount of resources, according to exemplary embodiments of the present invention, the handling of a flow of data (e.g., as indentified by an IP addresses, port numbers and protocol type) is dynamically adapted (e.g., by modifying scheduling weights).

In particular, according to exemplary embodiments of the present invention, the QoS framework of the state of the art is made more flexible by considering information like packet marks in addition to the QCI of a bearer in order to allow for a more fine granular and dynamic treatment of packet flows within a bearer.

It is identified as an issue with a differentiation of multiple packet data flows in the same evolved packet system (EPS) bearer that the existing QoS framework only allows differentiation between multiple bearers of a UE.

Hence, according to exemplary embodiments of the present invention, in-bearer differentiation of packet flows (e.g. in an eNB) is implemented.

Namely, while QoS enforcement points may be located in different places, a very likely enforcement point would be the eNB controlling the air interface resources of a number of cells.

Accordingly, in the following, the solution of the above identified problems according to the present invention is described by means of an eNB, in particular by measures performed at/by an eNB. However, the eNB is to be understood as a non-limiting example. In particular, the functionality according to the present invention may also be implemented in another logical network element, for example, between the serving gateway (S-GW) and the eNB. This network element may also be co-located to the eNB or the S-GW.

For adding a differentiation of packet flows in the same radio bearer (referred to as “in-bearer differentiation” in the following), according to the present invention the abovementioned restrictions of the existing QoS framework are considered.

In particular, according to the present invention, for the eNB implementation cross-layer information from higher sub-layers in priority handling and UE multiplexing is considered such that desired treatment/fairness properties (essentially between different packet flows of different UEs) result. Such cross-layer information may be, e.g., availability of data for transmission for a certain packet flow along with a QoS indicator (like a packet mark).

Different options exist for relaying information about the desired handling of a traffic flow from the QoS manager to the enforcement points. Solutions (re)using already existing signalling means like the QCI class being associated with an enhanced bearer or the DiffSery Code Point (DSCP) field in the header of an internet protocol (IP) packet are preferred. The latter mechanism is referred to as “marking” of packets such that a flow of packets can be identified and treated consistently by different enforcement points considering not only the marking but also other known parameters characterising the flow or the required QoS (thereby avoiding having to detect and classify packet flows in many different places by (deep) packet inspection).

According to exemplary embodiments of the present invention, the mentioned problems are solved considering the above outlined restrictions of existing techniques by means of an enforcement point, e.g. an eNB, for DL traffic.

Namely, according to exemplary embodiments of the present invention, utilization of cross-layer information from higher layers are utilized in order to enable a scheduler in the medium access control (MAC) layer to perform scheduling on packet flow granularity rather than on bearer granularity.

Such cross-layer information according to exemplary embodiments of the present invention does not only enable the distinction of different packet flows in a bearer, but also contains information with respect to the preferred treatment of a flow in the prioritization and multiplexing functionalities of the scheduler in the MAC layer. The prioritization and multiplexing functionalities in turn implements a certain fairness property.

According to exemplary embodiments of the present invention, the preferred sub-layer for generating this required information is the packet data convergence protocol (PDCP) layer, since on PDCP level, IP packets and with that all IP address information and any potentially associated information indicating the desired treatment of a IP packet flow is available (e.g., DSCP in the IP header). In addition, well-known deep packet inspection (DPI) techniques of higher layer protocols are available in the PDCP layer and might be used to perform per-flow classification.

In order to allow for in-bearer differentiation in MAC layer, according to exemplary embodiments of the present invention, at least logically separate data queues are required per packet flow to be differentiated (and generated) in order to allow a prioritized treatment of one flow over another if needed (this means also altering the packet sequence of a bearer from the one in which the packets arrived into the eNB).

Hence, essentially, according to exemplary embodiments of the present invention, MAC scheduler has a view on the different packet flows.

According to exemplary embodiments of the present invention, this per flow queuing is realized in PDCP layer (keeping the relation of a logical bearer in MAC corresponds to a single RLC and PDCP entity). However, the present invention is not limited thereto, and the person skilled in the art will realize that it is a matter of detailed implementation if this per flow queuing is rather realized in PDCP layer or in another way.

As according to exemplary embodiments of the present invention the per-flow queuing realized, according to those there are at least two options where scheduling is only done in MAC or where per bearer scheduling is done in PDCP and scheduling between bearers is handled in MAC.

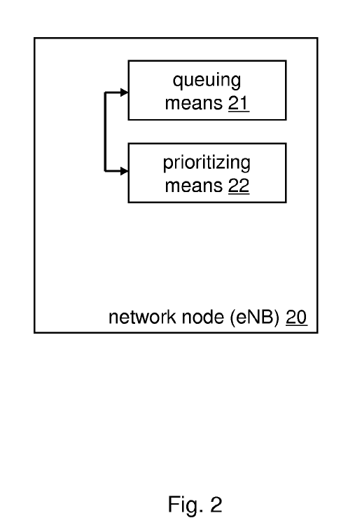

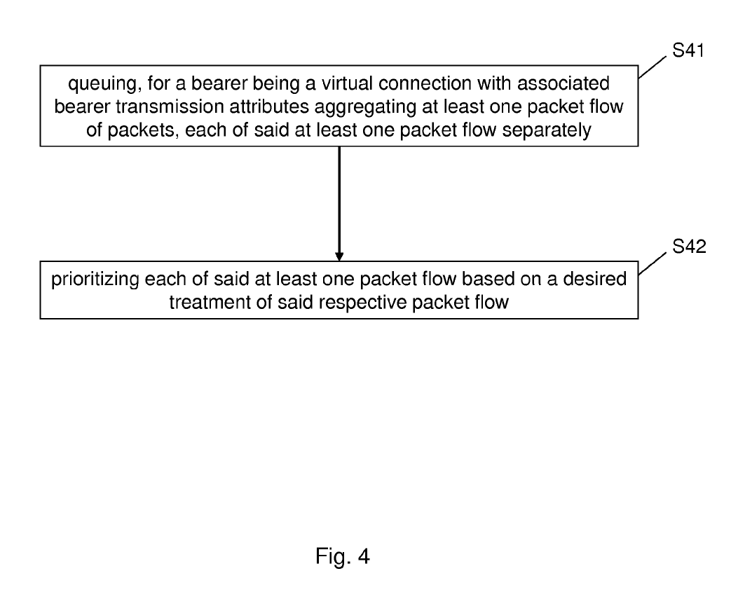

FIG. 2 is a block diagram illustrating an apparatus according to exemplary embodiments of the present invention. The apparatus may be a network node 20 such as a base station (e.g. eNB) comprising a queuing means 21 and a prioritizing means 22. The queuing means 21 queues, for a bearer being a virtual connection with associated bearer transmission attributes aggregating at least one packet flow of packets, each of said at least one packet flow separately. The prioritizing means 22 prioritizes each of said at least one packet flow based on a desired treatment of said respective packet flow. FIG. 4 is a schematic diagram of a procedure according to exemplary embodiments of the present invention. The apparatus according to FIG. 2 may perform the method of FIG. 4 but is not limited to this method. The method of FIG. 4 may be performed by the apparatus of FIG. 2 but is not limited to being performed by this apparatus.

As shown in FIG. 4, a procedure according to exemplary embodiments of the present invention comprises an operation of queuing (S41), for a bearer being a virtual connection with associated bearer transmission attributes aggregating at least one packet flow of packets, each of said at least one packet flow separately, and an operation of prioritizing (S42) each of said at least one packet flow based on a desired treatment of said respective packet flow.

Prioritizing each of said (at least one) packet flow includes giving a higher or a lower priority to a respective flow or keeping a priority of a respective flow. In other words, some flows of the at least one flow may be de-prioritized while the priority of some flows of the at least one flow may be maintained (i.e. not changed).

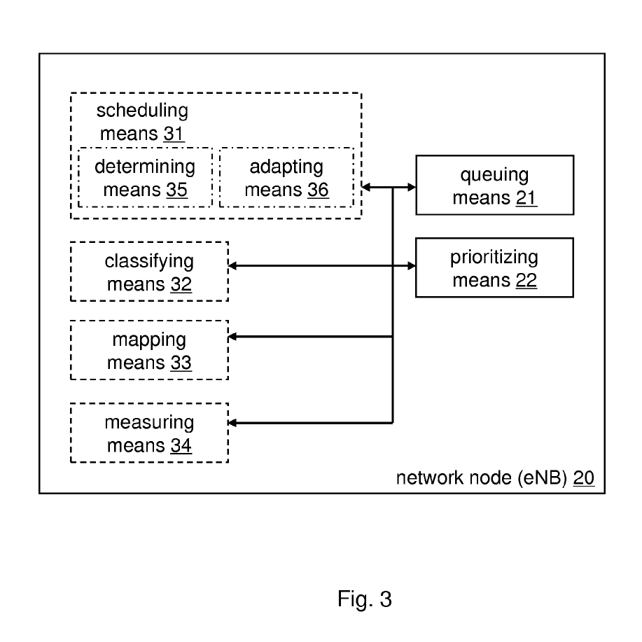

FIG. 3 is a block diagram illustrating an apparatus according to exemplary embodiments of the present invention. In particular, FIG. 3 illustrates a variation of the apparatus shown in FIG. 2. The apparatus according to FIG. 3 may thus further comprise, partly or together (i.e. any combination of), scheduling means 31, classifying means 32, mapping means 33, and measuring means 34. The scheduling means may further comprise determining means 35 and adapting means 36.

According to a variation of the procedure shown in FIG. 4, exemplary additional operations are given, which are inherently independent from each other as such. According to such variation, an exemplary method according to exemplary embodiments of the present invention may comprise an operation of scheduling said bearer of a plurality of bearers based on said bearer transmission attributes associated with said bearer, respectively. A result of said prioritizing (S42) may determine a sequence of handling said at least one packet flow of said bearer.

That is, according to exemplary embodiments of the present invention, a scheduling between bearers (mentioned as scheduling said bearer) is performed, and a scheduling between packet flows (mentioned as prioritizing each of said packet flows, while a result of said prioritizing may determine a sequence of handling said at least one packet flow of said scheduled bearer) is performed.

According to a variation of the procedure shown in FIG. 4, exemplary additional operations are given, which are inherently independent from each other as such. According to such variation, an exemplary method according to exemplary embodiments of the present invention may comprise an operation of classifying each packet of said bearer into a packet flow of said at least one packet flow based on information included in said packet. The packets are classified into a respective packet flow before being queued in the context of the respective packet flow.

Classifying the packets into a respective packet flow may according to exemplary embodiments of the present invention be performed by evaluating a certain mark, which may be e.g. a DSCP field in the header of an (IP) packet. According to further exemplary embodiments of the present invention, the classifying may, however, also be performed by a rule that derives the packet flow based on one or more packet attributes by utilizing deep packet inspection, for example, and by further measures.

In order to save resources, according to still further exemplary embodiments of the present invention, packet flows, queues, and corresponding characteristics/options may be set up dynamically depending on which packet arrives (arrived) In addition, rules, weights, adaptation functions etc. may be dynamically changed based on operation and maintenance (OAM) or some self optimizing functionality.

According to a variation of the procedure shown in FIG. 4, each of said packets may be provided with a mark of a plurality of marks indicative of said respective desired treatment of said respective packet flow. Further, according to said variation of the procedure shown in FIG. 4, exemplary additional operations are given, which are inherently independent from each other as such. According to such variation, an exemplary method according to exemplary embodiments of the present invention may comprise an operation of mapping said plurality of marks to a plurality of flow transmission attributes, respectively.

According to a variation of the procedure shown in FIG. 4, exemplary additional operations are given, which are inherently independent from each other as such. According to such variation, an exemplary method according to exemplary embodiments of the present invention may comprise an operation of measuring a per-flow throughput for each of said at least one packet flow.

According to a variation of the procedure shown in FIG. 4, exemplary details of the scheduling operation are given, which are inherently independent from each other as such.

Such exemplary scheduling operation according to exemplary embodiments of the present invention may comprise an operation of determining scheduling priorities for each bearer of said plurality of bearers based on said bearer transmission attributes associated with said bearer, respectively, and an operation of adapting said scheduling priorities based on at least one of said measured per-flow throughputs.

In particular, the adapting may depend on only one flow (which may for example be the flow with the highest priority), may depend on several flows (i.e. a selection out of all flows), or may depend on all flows.

According to a further variation of the procedure shown in FIG. 4, exemplary details of the scheduling operation are given, which are inherently independent from each other as such.

Such exemplary scheduling operation according to exemplary embodiments of the present invention may comprise an operation of adapting bearer scheduling weights and/or bearer nominal bit rates (NBR) and/or guaranteed bit rates based on said per-flow throughput.

According to a variation of the procedure shown in FIG. 4, said adapting is further based on sum weights and/or nominal bit rates and/or guaranteed bit rates of each of said packet flows of said plurality of bearers.

In addition, said adapting may further or instead be based on other functions like maximum bit rates and so on.

According to a variation of the procedure shown in FIG. 4, said bearer transmission attributes and/or said flow transmission attributes as mentioned above may comprise at least a quality of service parameter.

According to a variation of the procedure shown in FIG. 4, said scheduling is performed in a first sub-layer and said queuing (S41) and said prioritizing (S42) is performed in a second sub-layer higher than said first sub-layer, or alternatively, said prioritizing (S42) and said scheduling is performed in a first sub-layer and said queuing (S41) is performed in a second sub-layer higher than said first sub-layer.

That is, in other words, as a first alternative according to exemplary embodiments of the present invention, the priority scheduling between bearers is performed in the first sub-layer, and the priority scheduling between packet flows of a (scheduled) bearer is performed in the second sub-layer, and as a second alternative, both the priority scheduling between bearers and the priority scheduling between packet flows of a (scheduled) bearer is performed in the first sub-layer, while in either alternative the queuing of the respective packet flows is performed in the (higher) second sub-layer.

According to a further variation thereof, said first sub-layer is a Medium Access Control (MAC) sub-layer and said second sub-layer is a Packet Data Convergence Protocol (PDCP) sub-layer.

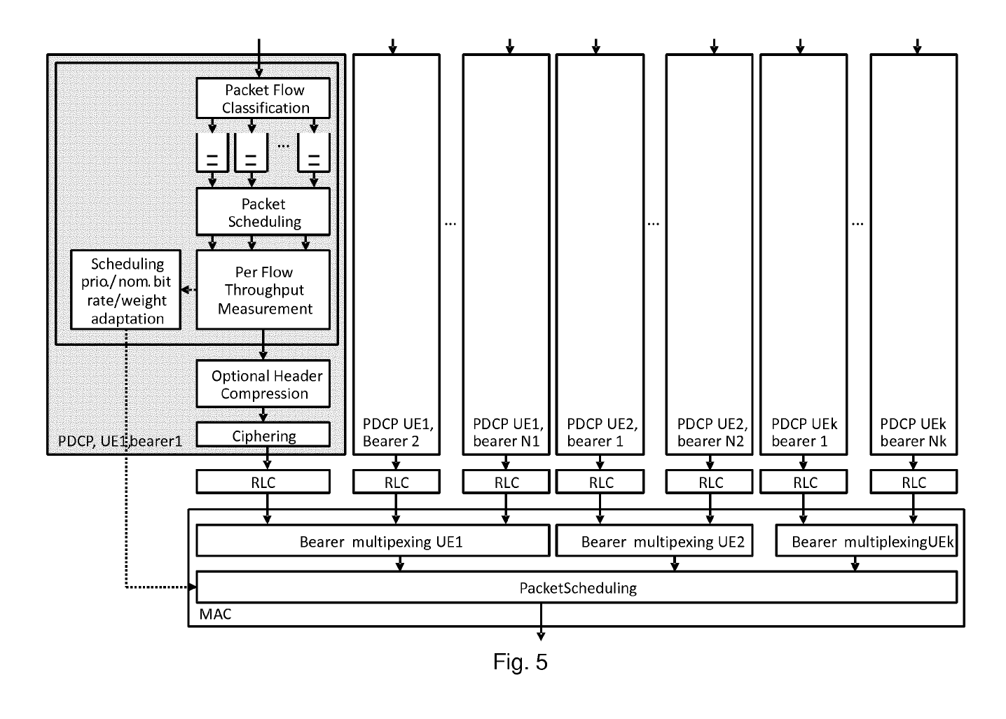

In other words, according to exemplary embodiments of the present invention, the following functionalities may be provided to solve the mentioned problems, which are exemplified by means of FIG. 5, which is a schematic diagram illustrating details of a layer 2 structure according to exemplary embodiments of the present invention.

Namely, packets may be classified into flows using information from the IP header (alternatively DPI might be use to classify the packets).

Further, the different packet flows may be queued separately.

Furthermore, a functionality of mapping of a packet/flow mark to a set of QoS parameters being applied in PDCP as well as in MAC (similar as the QCI in the existing architecture) may be provided.

In addition, a packet scheduling may be provided which prioritizes among the different packet flows of a bearer using basically the same QoS parameter and criteria as the scheduler in MAC sub-layer, for example, weight based and/or nominal bit rate based and/or guaranteed bit rate based scheduling per packet flow. The scheduling according to exemplary embodiments of the present invention determines the sequence in which to schedule the different flows within a bearer when MAC scheduler has decided to schedule the specific bearer of the UE.

Furthermore, measurement functionality may be provided to measure per-flow throughput for adaptation of scheduling priorities, scheduling weights, nominal bit rates (limited data arrival), or guaranteed bit rates.

In addition, a controlling functionality may be provided. The controlling functionality according to exemplary embodiments of the present invention derives adapted per-bearer scheduling priorities, scheduling weights, nominal bit rates, or guaranteed bit rates based on throughput measurements as well as the sum weights or sum nominal bit rates of all flows of a bearer to be considered in the MAC scheduler. In addition, other rules like maximum of priorities/weights/nominal bit rates might be used to derive the corresponding per bearer priorities, weights or nominal bit rates from per flow scheduling priorities, weights or nominal bit rates.

The scheduler in the MAC sub-layer may consider the priorities, weights or nominal bit rates as being provided by the scheduling functionality in (e.g.) PDCP in determining which bearer to schedule at a certain time (thereby ensuring intra- as well as inter-UE fairness between bearers).

Implementations according to exemplary embodiments of the present invention may be tailored to fit with the existing prioritization and multiplexing mechanism as being implemented by the MAC scheduler for the radio interface in eNBs.

The current packet scheduler may support a weighted proportional fair scheduling strategy for non guaranteed bit rate (non-GBR) data radio bearers, which may be extended by a delay-based component in order to support guaranteed bit rate (GBR) data radio bearers. In addition, a nominal bit rate for non-GBR bearers to provide a minimum quality of service may be supported.

The priority with which a certain UE is scheduled may be determined by the bearer specific weight factors along with the information about data availability. In particular, the priority of a certain UE may be determined as the sum of the weights of all bearers having data to be transmitted.

While bearer weight may be derived from a configuration value (per each supported QCI), this weight may also be dynamically adapted to account for limited data arrival of a bearer in order to prevent general unfairness being caused to especially other UEs. In this regard, limited data arrival refers to the amount of arriving data for a certain bearer being limited such that the throughput ratio between the bearers of a UE as corresponding to the ratio of bearer weights can not be reached.

Per bearer throughput measurements may be the basis for this adaptation of weights. A similar mechanism exists for the support of the nominal bit rate that the scheduler tries to allocate to a non-GBR bearer if there are data in buffer for this bearer. Those per bearer throughput measurements may also be the basis for a dynamic adjustment of a guaranteed bit rate for a GBR-bearer.

According to exemplary embodiments of the present invention, this approach is easily extended to per flow differentiation as discussed above, by effecting that all packet flows requiring a differentiated treatment instead of only the bearers become visible in the MAC scheduler. According to exemplary embodiments of the present invention, this may be realized by adding another functional entity in a higher sub-layer, acting as a first scheduling level providing the per flow information across layers to the MAC scheduler. According to exemplary embodiments of the present invention it is preferred to make this first scheduling level a part of the PDCP entity.

According to exemplary embodiments of the present invention, the QoS enforcement point, i.e., the eNB may support configuration options to associate flow/packet marks with QoS parameters (similar to the QoS parameters being associated with a QCI) to be applied in PDCP as well as in MAC scheduling steps. In addition, packet classification rules may be configured according to the present invention.

It is noted that according to a more complex alternative to the implementations according to exemplary embodiments of the present invention discussed above, per packet class buffering may be done in PDCP sub-layer, and the scheduling my be handled solely in MAC sub-layer. This approach requires very fast signalling between PDCP and MAC to inform MAC on the buffering status of all packet flows. MAC may then decide on which packets are to be served from which flows/bearers and inform PDCP of this decision. The subsequent packet processing in RLC is then be done in real-time.

According to exemplary embodiments of the present invention it is achieved that bearer and flow differentiation can be done seamlessly at the same time allowing for maximum flexibility for QoS differentiation. Potential applications thereof may be, among others, preferred treatment of transmission control protocol (TCP) acknowledgements for uplink (UL) TCP traffic compared to TCP downlink data, upscaling of bearer priorities with higher number of TCP connections that are mapped to the bearer, and prioritization of user datagram protocol (UDP) traffic against TCP traffic within a bearer.

Implementations according to discussed exemplary embodiments of the present invention fit well within existing eNB software architecture and implementation of service differentiation. It may be extended easily to perform differentiation for other traffic types (e.g., GBR traffic). If differentiation according to the present invention is performed for GBR, the guaranteed bit rate per se may be dynamically adjusted based on the packet flow needs. Differentiation according to the present invention for NBR would work similar to the differentiation for GBR.

The implementations also fit very well to advanced existing as well as upcoming features and functionalities like, among others, carrier aggregation (also decentralized scheduling for carrier aggregation), dual connectivity, coordinated multipoint transmission (CoMP) with dynamic point selection, where the traffic of one UE or one bearer is transmitted via different transmission points (either a separate cell of the same or even another eNB or at least a separate transmission point with different individual coverage together comprising one macro cell). Here, the optimum transmission point for the traffic of one UE or one bearer may be dynamically selected. A further advanced feature to which the implementations fits may also be joint transmission CoMP, where the data are simultaneously transmitted to a UE or a bearer from several transmission points.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

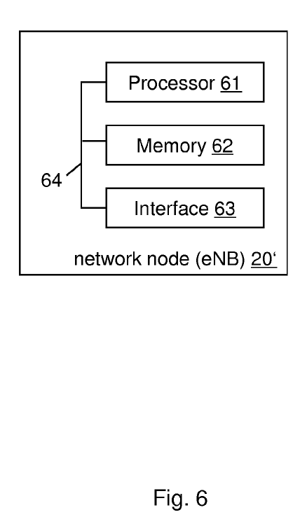

In FIG. 6, an alternative illustration of an apparatus according to exemplary embodiments of the present invention is depicted. As indicated in FIG. 6, according to exemplary embodiments of the present invention, the apparatus (network node) 20′ (corresponding to the network node 20) comprises a processor 61, a memory 62 and an interface 63, which are connected by a bus 64 or the like, and may be connected via the interface 63 with other apparatuses.

The processor 61 and/or the interface 63 may also include a modem or the like to facilitate communication over a (hardwire or wireless) link, respectively. The interface 63 may include a suitable transceiver coupled to one or more antennas or communication means for (hardwire or wireless) communications with the linked or connected device(s), respectively. The interface 63 is generally configured to communicate with at least one other apparatus, i.e. the interface thereof.

The memory 62 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the network node 20 comprises at least one processor 61, at least one memory 62 including computer program code, and at least one interface 63 configured for communication with at least another apparatus. The processor (i.e. the at least one processor 61, with the at least one memory 62 and the computer program code) is configured to perform queuing, for a bearer being a virtual connection with associated bearer transmission attributes aggregating at least one packet flow of packets, each of said at least one packet flow separately (thus the apparatus comprising corresponding means for queuing), and to perform prioritizing each of said at least one packet flow based on a desired treatment of said respective packet flow (thus the apparatus comprising corresponding means for prioritizing).

In particular, according to exemplary embodiments of the present invention, an apparatus representing the network node 20 comprises at least one processor 61, at least one memory 62 including computer program code, and at least one interface 63 configured for communication with at least another apparatus. The processor (i.e. the at least one processor 61, with the at least one memory 62 and the computer program code) is configured to cause the apparatus to queue, for a bearer being a virtual connection with associated bearer transmission attributes aggregating at least one packet flow of packets, each of said at least one packet flow separately, and to prioritize each of said at least one packet flow based on a desired treatment of said respective packet flow.

The processor (i.e. the at least one processor 61, with the at least one memory 62 and the computer program code) may further be configured to cause the apparatus to schedule said bearer of a plurality of bearers based on said bearer transmission attributes associated with said bearer, respectively (wherein a result of said prioritizing determines a sequence of handling said at least one packet flow of said bearer), to classify each packet of said bearer into a packet flow of said at least one packet flow based on information included in said packet, to map said plurality of marks to a plurality of flow transmission attributes, respectively, to measure a per-flow throughput for each of said at least one packet flow, to determine scheduling priorities for each bearer of said plurality of bearers based on said bearer transmission attributes associated with said bearer, respectively, to adapt said scheduling priorities based on at least one of said measured per-flow throughputs, to adapt bearer scheduling weights and/or bearer nominal bit rates and/or guaranteed bit rates based on said per-flow throughput, and/or to adapt further based on sum weights and/or nominal bit rates of each of said packet flows of said plurality of bearers.

For further details regarding the operability/functionality of the apparatus, reference is made to the above description in connection with any one of FIGS. 2 to 5, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for dynamic quality of service management. Such measures exemplarily comprise queuing, for a bearer being a virtual connection with associated bearer transmission attributes aggregating at least one packet flow of packets, each of said at least one packet flow separately, and prioritizing each of said at least one packet flow based on a desired treatment of said respective packet flow.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### List of Acronyms and Abbreviations

### 3GPP 3^{rd} Generation Partnership Project

CoMP coordinated multipoint transmission
DL downlink
DPI deep packet inspection

### DSCP DiffSery Code Point

eNB evolved NodeB, eNodeB
EPC enhanced packet core
EPS evolved packet system
GBR guaranteed bit rate
IP internet protocol

### LTE Long Term Evolution

MAC medium access control
NBR nominal bit rate
non-GBR non guaranteed bit rate
OAM operation and maintenance
PDCP packet data convergence protocol
PDU protocol data unit
QCI quality of service class identifier, QoS class identifier
QoS quality of service
RLC radio link control
SDU service data unit
TCP transmission control protocol
TS technical specification
UDP user datagram protocol
UE user equipment
UL uplink

### UMTS Universal Mobile Telecommunications System

1. A method, comprising
queuing, for a bearer being a virtual connection with associated bearer transmission attributes aggregating at least one packet flow of packets, each of said at least one packet flow separately, and
prioritizing each of said at least one packet flow based on a desired treatment of said respective packet flow.

2. The method according to claim 1, further comprising
scheduling said bearer of a plurality of bearers based on said bearer transmission attributes associated with said bearer, respectively, wherein
a result of said prioritizing determines a sequence of handling said at least one packet flow of said bearer.

3. The method according to claim 1, further comprising
classifying each packet of said bearer into a packet flow of said at least one packet flow based on information included in said packet.

4. The method according to claim 2, further comprising
measuring a per-flow throughput for each of said at least one packet flow, and, wherein
in relation to said scheduling, said method further comprises
determining scheduling priorities for each bearer of said plurality of bearers based on said bearer transmission attributes associated with said bearer, respectively, and
adapting said scheduling priorities based on at least one of said measured per-flow throughputs.

5. The method according to claim 4, wherein
in relation to said scheduling, said method further comprises
adapting bearer scheduling weights and/or bearer nominal bit rates and/or guaranteed bit rates based on said per-flow throughput.

6. The method according to claim 4, wherein
said adapting is further based on sum weights and/or nominal bit rates of each of said packet flows of said plurality of bearers.

7. The method according to claim 2, wherein
said scheduling is performed in a first sub-layer and said queuing and said prioritizing is performed in a second sub-layer higher than said first sub-layer, or wherein
said prioritizing and said scheduling is performed in a first sub-layer and said queuing is performed in a second sub-layer higher than said first sub-layer.

8. An apparatus, comprising
queuing means configured to queue, for a bearer being a virtual connection with associated bearer transmission attributes aggregating at least one packet flow of packets, each of said at least one packet flow separately, and
prioritizing means configured to prioritize each of said at least one packet flow based on a desired treatment of said respective packet flow.

9. The apparatus according to claim 8, further comprising
scheduling means configured to schedule said bearer of a plurality of bearers based on said bearer transmission attributes associated with said bearer, respectively, wherein
a result of said prioritizing determines a sequence of handling said at least one packet flow of said bearer.

10. The apparatus according to claim 8, further comprising
classifying means configured to classify each packet of said bearer into a packet flow of said at least one packet flow based on information included in said packet.

11. The apparatus according to claim 9, further comprising
measuring means configured to measure a per-flow throughput for each of said at least one packet flow,
determining means configured to determine scheduling priorities for each bearer of said plurality of bearers based on said bearer transmission attributes associated with said bearer, respectively, and
adapting means configured to adapt said scheduling priorities based on at least one of said measured per-flow throughputs.

12. The apparatus according to claim 11, wherein
said adapting means is further configured to adapt bearer scheduling weights and/or bearer nominal bit rates and/or guaranteed bit rates based on said per-flow throughput.

13. The apparatus according to claim 11, wherein
said adapting is further based on sum weights and/or nominal bit rates of each of said packet flows of said plurality of bearers.

14. The apparatus according to claim 9, wherein
said scheduling is performed in a first sub-layer and said queuing and said prioritizing is performed in a second sub-layer higher than said first sub-layer, or wherein
said prioritizing and said scheduling is performed in a first sub-layer and said queuing is performed in a second sub-layer higher than said first sub-layer.

15. The apparatus according to claim 8, wherein
the apparatus is operable as or at a base station or access node of a cellular system, and/or
the apparatus is operable in at least one of a LTE and a LTE-A cellular system.

16. A computer program product comprising computer-executable computer program code which, when the program is run on a computer, is configured to cause the computer to carry out the method according to claim 1.

17. The computer program product according to claim 16, wherein the computer program product comprises a computer-readable medium on which the computer-executable computer program code is stored, and/or wherein the program is directly loadable into an internal memory of the processor.
